(19) United States
(12) Patent Application Publication
(10) Pub. No.: US 2026/0021546 A1
(43) Pub. Date: Jan. 22, 2026

(54) DEVICE FOR CLAMPING AND UNCLAMPING TEMPORARY FASTENERS

(71) Applicant: Airbus Operations S.L.U., GETAFE (ES)

(72) Inventor: Pablo CEBOLLA GARROFE, GETAFE (ES)

(21) Appl. No.: 19/266,441

(22) Filed: Jul. 11, 2025

(30) Foreign Application Priority Data
Jul. 19, 2024 (EP) 24382791.2

(51) Int. Cl. B23P 19/06

(52) U.S. Cl. CPC B23P 19/06

(57) ABSTRACT

A device for clamping and unclamping temporary fasteners is stored in an automatic tool changer and is introduced automatically in an end effector. The device clamps and unclamps temporary fasteners without manual intervention. It applies torque to the fastener's screw via an inner drive, typically using a hexagonal head actuated by an electrical screwdriver. The device has a support for the fastener, a holder for the rotating tool that rotates with the support to clamp or unclamp the fastener, and an outer body with an anti-rotation profile between the support and the holder.

### CROSS-REFERENCES TO RELATED APPLICATIONS

This application claims the benefit of the European Application No. 24382791.2, filed on 19 Jul. 2024, the entire disclosures of which are incorporated herein by way of reference.

### FIELD OF THE INVENTION

The present invention relates to a device for clamping and unclamping temporary fasteners.

### BACKGROUND OF THE INVENTION

A device for temporary fasteners is a passive tool that can be stored in an automatic tool changer and introduced automatically in an end effector to perform the task of clamping and unclamping the temporary fasteners without any manual intervention.

In a device for clamping and unclamping temporary fasteners an inner drive applies torque to a screw of the temporary fastener through rotation. It normally has a hexagonal head to be actuated by an electrical screwdriver. Drilling end effectors have a robust exchangeable tool holder to allow big torques and high-speed rotation in an accurate way.

A part of the device, such as a hexagonal head or a cylinder with flat faces is typically held or fixed to the end effector, to provide an anti-rotation effect for the temporary fastener. If the inner drive mechanism is connected to the torque source and rotates, there is the need for an external mechanism to be supplying anti-rotation to the outer portion of the end effector which holds the body.

Therefore, actual devices for clamping and unclamping temporary fasteners need extra actuation on the tool to clamp and unclamp the temporary fasteners in position and need an anti-rotation element that forces it to have specific end effector for this purpose, which increases the costs and complexity of the device.

### SUMMARY OF THE INVENTION

Therefore, an objective of the present invention is to provide a device for clamping and unclamping temporary fasteners in which no extra end effector is needed or complicated actuation, reducing the costs and complexity and allowing the use of a drilling end effector for drilling and for clamping and unclamping temporary fasteners.

The device for clamping and unclamping temporary fasteners of the invention solves the above-mentioned disadvantages and has other advantages which will be described below.

The device for clamping and unclamping temporary fasteners according to the present invention is described in claim 1, and the dependent claims include additional features that are optional.

In particular, the device for clamping and unclamping temporary fasteners comprises:
a support for a temporary fastener;
a holder for a rotating tool, said holder rotating with the support, so that a rotation in a direction clamps the temporary fastener, and a rotation in an opposite direction unclamps the temporary fastener; and
an outer body provided with an anti-rotation profile, placed between the support and the holder.

Advantageously, said anti-rotation profile comprises a plurality of protrusions or flat faces placed around the outer body, and preferably the outer body is cylindrical.

Furthermore, the device for clamping and unclamping temporary fasteners according to the present invention also comprises an adapter placed between the holder and the outer body.

According to a preferred embodiment, the outer body comprises an inner body inside it, that is movable against the bias of a spring.

Furthermore, the holder preferably comprises an internal engaging interface for engaging a rotating tool.

With the device for clamping and unclamping temporary fasteners according to the present invention, it is avoided any extra system needed to actuate a temporary fastener tool and transform the tool into a passive system able to be operated by any spindle use for drilling needing only the normal rotation of the spindle and the advance and retraction motion of it.

Therefore, no extra end effector is needed or complicated actuation, reducing the costs and complexity of the device and allowing the use of a drilling end effector for clamping and unclamping temporary fasteners.

### BRIEF DESCRIPTION OF THE DRAWINGS

For a better understanding of what has been explained above, some drawings are included in which, schematically and only by way of a non-limiting example, a practical case of embodiment is represented.

FIG. 1 is a perspective view of the device for clamping and unclamping temporary fasteners according to the present invention;

FIG. 2 is a side view of the device for clamping and unclamping temporary fasteners according to the present invention; and

FIG. 3 is a longitudinal-section side view of the device for clamping and unclamping temporary fasteners according to the present invention.

### DETAILED DESCRIPTION OF THE PREFERRED EMBODIMENTS

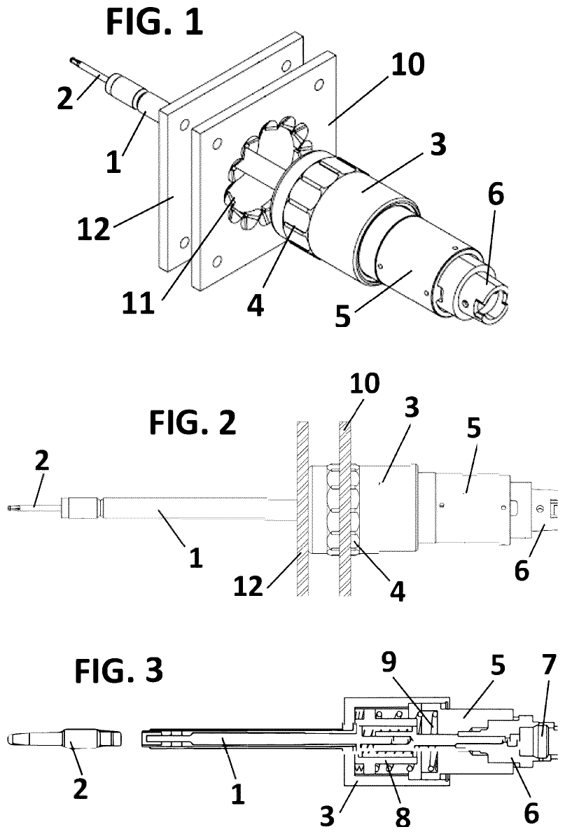

FIGS. 1-3 show the device for clamping and unclamping temporary fasteners according to the present invention.

The device according to the present invention comprises a support (1) for supporting a temporary fastener (2), said support having an elongated shape.

Next to the support (1) the device comprises an outer body (3) comprising an external anti-rotation profile (4), said anti-rotation profile (4) including a plurality of protrusions or flat faces, i.e., a profile that is not circular.

The outer body (3) is preferably cylindrical, and the anti-rotation profile (4) extends around the whole periphery of the outer body (3), as shown in FIGS. 1 and 2.

Next to the outer body (3), the device comprises an adapter (5) and at an end of this adapter (5), a holder (6) for a rotatable tool, such as e.g., a drilling tool, not shown in the drawings.

The holder (6) and the support (1) are linked to each other, being rotatably integral to each other, i.e., the support (1) rotates in the same direction that the holder (6).

This way, when the holder (6) is rotated in one direction, the temporary fastener (2), fixed to the support (1), is clamped, and when the holder (6) rotates in the opposite direction, the temporary fastener (2) is unclamped.

In FIG. 3 the internal components of the device according to the present invention are shown, wherein the holder (6) comprises an engaging interface (7) for engaging the rotating tool. This engaging interface (7) is complementary with the adapter (5), so that a predetermined type of rotating tool can be inserted, e.g. a HSK32 profile, even though it can be any suitable interface.

Furthermore, inside the outer body (3) an inner body (8) is placed, that is longitudinally movable inside said outer body (3) for the different operation modes.

In operation, and for permitting the anti-rotation function, the anti-rotation profile 4 is housed inside a complementary hole (11) of an end effector frame plate (10), shown in FIGS. 1 and 2, and the support (1) crosses an end effector frame (12).

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

What is claimed is:

1. A device for clamping and unclamping temporary fasteners, comprising:
a support for a temporary fastener;
a holder for a rotating tool, said holder rotating with the support, so that a rotation in a direction clamps the temporary fastener, and a rotation in an opposite direction unclamps the temporary fastener; and
an outer body provided with an anti-rotation profile, placed between the support and the holder.

2. The device for clamping and unclamping temporary fasteners according to claim 1, wherein said anti-rotation profile comprises a plurality of protrusions or flat faces placed around the outer body.

3. The device for clamping and unclamping temporary fasteners according to claim 2, wherein the outer body is cylindrical.

4. The device for clamping and unclamping temporary fasteners according to claim 3, wherein the device also comprises an adapter placed between the holder and the outer body.

5. The device for clamping and unclamping temporary fasteners according to claim 4, wherein the outer body comprises an inner body placed inside it, that is movable against the bias of a spring.

6. The device for clamping and unclamping temporary fasteners according to claim 5, wherein the holder comprises an internal engaging interface for engaging a rotating tool.
